(19) United States
(12) Patent Application Publication
(10) Pub. No.: US 2013/0108536 A1
(43) Pub. Date: May 2, 2013

(54) Methane Abatement With Ozone

(71) Applicant: Yohan Alexander Sumathipala, Ashburn, VA (US)

(72) Inventor: Yohan Alexander Sumathipala, Ashburn, VA (US)

(21) Appl. No.: 13/284,929

(22) Filed: Oct. 30, 2011

(51) Int. Cl. B01D 53/72

(52) U.S. Cl. 423/245.1

(57) ABSTRACT

Decomposing methane released by landfill sites, swamps, mining, and other activities into carbon dioxide would reduce global warming. The global warming potential of methane is several folds higher than that of carbon dioxide. As such, decomposing methane into carbon dioxide would result in a reduction of global warning. Additionally, it occasionally becomes necessary to abate methane to mitigate otherwise hazardous conditions created by accumulation of methane in confined spaces, such as, underground mines or buildings.

A novel method of decomposing methane, even when present in low concentrations, is disclosed. In the method described, ozone is added to the methane-air mixture and passed over a catalyst. Methane reacts with ozone in the presence of the catalyst and decomposes into carbon dioxide and water.

### BACKGROUND AND PRIOR ART

Methane and other hydrocarbons are green house gases in that they contribute to global warming. Some hydrocarbons contribute more toward global warming than others. Methane, in particular, makes a high contribution to trapping heat and thus to global warming. One way to combat global warming is to convert a gas that makes a higher contribution to global warming to one that makes a lower contribution before releasing to the atmosphere. Methane's global warming potential is 21 times that of carbon dioxide. Thus, conversion of methane into carbon dioxide before being released to the atmosphere would abate global warming.

Landfills account for 23% of U.S. methane emissions at 13 billion tons in 2007, according to the Environmental Protection Agency. At some landfills, primarily large operations, methane is burned to produce energy or simply flared. However in others, typically medium-to-small landfills, methane is allowed to diffuse into the atmosphere. Methane is also released into the atmosphere by other processes, such as, mining, and swamps. The novel process disclosed here provides a method to convert methane, originating from any source, whether it be landfills, swamps, or mining to carbon dioxide to substantially reduce methane's otherwise global warming footprint.

Decomposing methane, at concentrations greater than 6%, into carbon dioxide is commonly and conveniently accomplished by flaring. Decomposing methane, at concentrations below 6% is, however, difficult. This is primarily due methane's stable tetrahedral molecular structure. Previous work shows that decomposing methane at low concentrations into carbon dioxide require raising the reactant temperature to above 650° C. when a suitable catalyst is used, or above 1000° C. without a catalyst. In addition, these conversions were not successful at methane concentrations below 3%. In 1960, Dillmuth et al. reported on tests conducted by mixing methane and ozone. They showed that under ideal laboratory conditions, methane mixed with ozone converted primarily into carbon dioxide. In 2008, the doctoral thesis research by Hui showed that methane can be converted to carbon dioxide with ozone. Dillmuth et al., and, later, Hui conducted their experiments at high concentrations of methane and at temperatures exceeding 500° C. This concept of methane and ozone reaction was applied in the present invention with the addition of a suitable catalyst. The introduction of a catalyst made the methane and ozone reaction possible even at low methane concentrations. It also lowered the reaction temperature to near room temperature.

Several U.S. patents have revealed processes for converting methane into products that have a lower impact on global warming. They are:

U.S. Pat. Nos. 7,094,384 and 6,986,870 to Brandenburg, and U.S. Pat. No. 7,794,526 to Caro deal with conversion of methane into ammonia but require methane in high concentrations,

U.S. Pat. Nos. 7,587,999 and 7,363,883 to Ito et al. deal with conversion of methane into carbon dioxide but require methane in concentrations higher than 30%.

U.S. Pat. No. 6,205,793 to Schimp deals with collection of methane gas from underground mines for subsequent treatment or disposal.

The methods and processes disclosed in the above patents are deficient in that they need methane in concentrations of at least 30% for methane abatement to occur. None of these patents address abatement when methane is present in concentrations as low as 6%. The present invention fills the need to abate methane when methane is present in such low concentrations.

### SUMMARY

### The Field of the Invention

Methane produced by landfill sites, swamps, and mines at concentrations above 6% can be decomposed by flaring. However, methane-air mixtures where the methane concentration is below 6% would not combust, and cannot be flared. A process for abating methane, by decomposing it into carbon dioxide, even when methane is present in low concentrations, is disclosed.

The present invention relates generally to decomposing of methane, generated from waste streams, into carbon dioxide by reacting with ozone in the presence of a catalyst. The method is applicable to abatement of greenhouse gas effects of atmospheric methane. Another application of the present invention is the development of a handheld or a portable device to safely abate methane to mitigate hazardous conditions created in unintentional releases of natural gases into confined spaces. Such situations occur in underground mine operations or in unintentional natural gas leaks in buildings.

Four embodiments of the present invention are presented. In the first embodiment, a methane-air stream is mixed with ozone and passed over a catalyst to decompose methane into carbon dioxide. In a second embodiment, the methane-air stream and ozone mixture is preheated and passed over a catalyst to decompose methane. In a third embodiment, the methane-air stream is mixed with ozone and passed over a heated catalyst to decompose methane into carbon dioxide. In a fourth embodiment, the methane-air stream and ozone mixture is preheated and passed over a heated catalyst to decompose methane into carbon dioxide. Decomposition efficiency is controlled by varying methane-air flow rate, ozone flow rate, temperature of reactants, and temperature of the catalyst.

### DESCRIPTION OF THE FIGURES

FIGS. 1 through 4 show possible embodiments of the present invention. Referring to the four figures, wherein numbers are assigned to designate like or corresponding parts or streams. Number 12 refer to the incoming methane-air stream whose methane is to be abated by the present invention. This stream can contain a methane concentration as low as 3%. Number 13 refer to a device that can heat the incoming methane-air stream. It can be a device, such as an electrical resistance heater, placed within the methane-air stream, or a device that can apply heat from the outside. Number 14 refer to an ozone generator. Ozone is a molecule composed of three atoms of oxygen, one more than ambient oxygen. The third oxygen in ozone can detach from the ozone molecule, and re-attach to methane molecules decomposing methane. Several types of ozone generators are available and any method of generation would be suitable for the present invention. Number 15 refer to a device that can heat the methane-air and ozone mixture. It can be a device placed within the stream or a device that apply heat from the outside. 15 can be used in lieu of or in addition to 13. Number 16 refer to a catalyst. The methane-air and ozone mixture would be made to pass over the catalyst. 18 refer to outgoing methane-abated air stream. Number 20 refer to a device that can raise the temperature of the catalyst. Heat may be applied from the outside to raise the catalyst temperature.

### DESCRIPTION OF THE EMBODIMENTS

### Embodiment 1

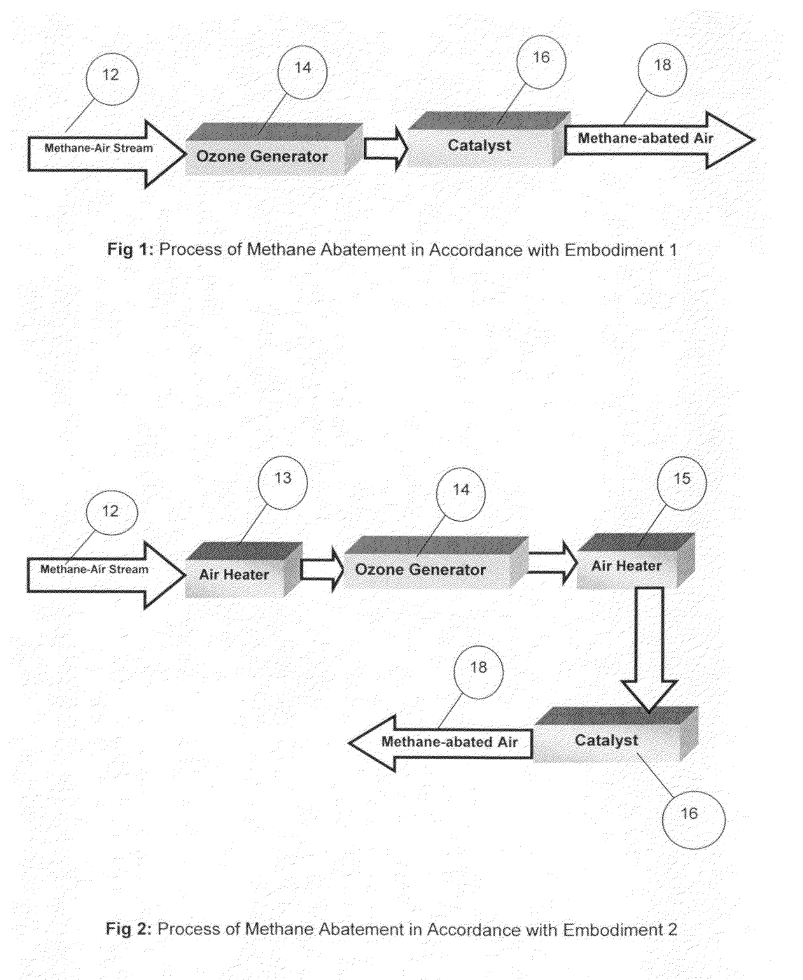

In this embodiment, shown in FIG. 1, a methane-air stream, 12, is mixed with ozone, generated by the ozone generator, 14, and passed over a catalyst 16. Methane is decomposed into carbon dioxide by reacting with ozone in the presence of the catalyst. At least three catalysts were capable of decomposing methane into carbon dioxide in this embodiment. They are: titanium dioxide, platinum-palladium-rhodium; and transition metal-doped zeolite. Conversion efficiency can be changed by varying one or both of the methane-air flow rate, or the ozone flow rate.

### Embodiment 2

In this embodiment, shown in FIG. 2, a methane-air stream, 12, is heated in 13 to raise its temperature. This stream is then mixed with ozone, generated by the ozone generator, 14. As an alternate or as a supplement to 13, heating may be applied to the methane-air and ozone stream in 15. The preheated mixture of methane-air and ozone is then passed over catalyst 16. Methane. is decomposed into carbon dioxide by reacting with ozone in the presence of the catalyst. At least four catalysts were capable of decomposing methane into carbon dioxide in this embodiment. They are platinum-palladium-rhodium; zeolite, transition metal-doped zeolite, and titanium dioxide. Conversion efficiency can be changed by the varying one or more of, the temperature of methane-air and ozone mixture, methane-air mixture flow rate, and the ozone flow rate.

### Embodiment 3

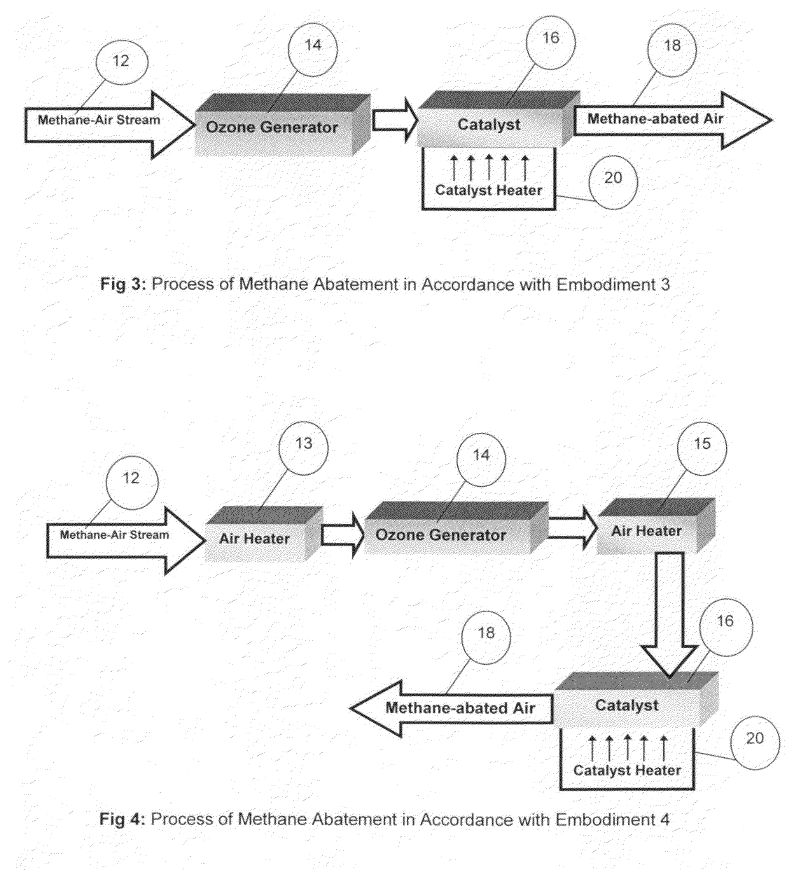

In this embodiment, shown in FIG. 3, a methane-air stream, 12, is mixed with ozone, generated by the ozone generator, 14, and passed over catalyst 16. The catalyst temperature is raised by heater 20. Methane is decomposed into carbon dioxide by reacting with ozone in the presence of the heated catalyst. At least four catalysts were capable of decomposing methane into carbon dioxide in this embodiment. They are: titanium dioxide, platinum-palladium-rhodium; transition metal-doped zeolite, and zeolite. Conversion efficiency can be changed by varying one or more of, the catalyst temperature, methane-air mixture flow rate, and the ozone flow rate.

### Embodiment 4

In this embodiment, shown in FIG. 4, a methane-air stream, 12, is heated in 13 to raise its temperature. This stream is then mixed with ozone, generated by the ozone generator, 14. As an alternate or as a supplement to 13, heating may be applied to the methane-air and ozone stream in 15. The preheated mixture of methane-air and ozone is then passed over catalyst 16. The catalyst temperature is raised by heater 20. Methane is decomposed into carbon dioxide by reacting with ozone in the presence of the heated catalyst. At least four catalysts were capable of decomposing methane into carbon dioxide in this embodiment. They are, platinum-palladium-rhodium; titanium dioxide, transition metal-doped zeolite, and zeolite. Conversion efficiency can be changed by varying one or more of, the catalyst temperature, methane-air mixture flow rate, and the ozone flow rate.

### Conclusion

The present invention reveals a process to reduce global warming effect by decomposing methane released by landfill sites, swamps, and mining activities to carbon dioxide. Global warming potential of methane is about 21 times that of carbon dioxide. As such, decomposing methane to carbon dioxide reduce global warming potential. There are several advantages of the present invention. The process revealed is capable of decomposing methane-air mixtures with methane concentrations as low as 3% into carbon dioxide. Additionally, the process revealed allow for the development of a portable device to decompose methane. Such a device could be useful to abate methane when its a safety hazard, such as in underground mines or in accidental releases of natural gas in buildings.

### REFERENCES CITED

### U.S. Patent Documents

| | | |
|---|---|---|
| 7,094,384 | September 2005 | Brandenburg |
| 6,986,870 | August 2003 | Brandenburg |
| 7,587,999 | March 2008 | Ito et al. |
| 7,363,883 | March 2004 | Ito et al. |
| 6,205,793 | July 1999 | Schimp |

### Other Documents

Hui, K. S., Use of Zeolite-Based Micro-Porous Materials in Enhancing Methane Combustion Performance, Mechanical Engineering Doctoral Theses, Hong Kong University of Science and Technology, HKUST Call Number: Thesis MECH 2008 Hui, 2008.

Dillemuth F. J., Skidmore, D. R., Schubert, C. C., The Reaction Of Ozone With Methane, J. Phys. Chem., 64 (10), pp 1496-1499, 1960.

I claim:

1. A method of decomposing methane from a gaseous mixture of methane and air comprising the steps of:
a. Mixing said gaseous mixture with ozone and,
b. Preheating the gaseous mixture with ozone
c. Passing said gaseous mixture with ozone through or over a catalyst to cause methane to decompose.

2. The method of decomposition according to claim 1 wherein, the catalyst is one or a combination of the following:
a. Platinum-palladium-rhodium,
d. Zeolite,
e. Zeolite doped with a transition metal,
f. Titanium dioxide.
